(19) United States
(12) Patent Application Publication
(10) Pub. No.: US 2009/0048813 A1
(43) Pub. Date: Feb. 19, 2009

(54) SIMULATION METHOD AND SIMULATION PROGRAM

(76) Inventors: Takashi Ichikawa, Saitama-ken (JP); Naoki Tamaoki, Tokyo (JP); Toshiro Takase, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/192,197

(22) Filed: Aug. 15, 2008

(30) Foreign Application Priority Data
Aug. 16, 2007 (JP) 2007-212419

(51) Int. Cl. G06F 17/10

(52) U.S. Cl. 703/2

(57) ABSTRACT

A simulation method is configured to simulate a feature profile of a material surface. The simulation method includes using an algorithm of repeating a step of calculating a surface growth rate and a step of skipping the calculation of the surface growth rate. The surface growth rate is calculated in the step of skipping the calculation of the algorithm if the material surface traverses a material interface.

### CROSS-REFERENCE TO RELATED APPLICATIONS

This application is based upon and claims the benefit of priority from the prior Japanese Patent Application No. 2007-212419, filed on Aug. 16, 2007; the entire contents of which are incorporated herein by reference.

### BACKGROUND OF THE INVENTION

1. Field of the Invention

This invention relates to a simulation method and a simulation program for simulating the feature profile of a material surface such as a semiconductor device.

2. Background Art

In the processing of a material surface using reactive ion etching and the like, simulation of the feature profile is a necessary technique for sophisticated process control. Semiconductor manufacturing processes including fine processing require high accuracy in process controllability, and simulation also requires similar high accuracy.

Simulation of the feature profile of a material surface is typically performed by dividing the time evolution of the material surface in a microstructure into finite time steps, calculating the surface growth rate in each time step, and computing the surface profile after the time step. There is a simulation method for determining the feature profile by dividing a material surface into finite computational elements, determining a local flux at each computational element, and calculating a surface growth rate for each time step based on a surface reaction model (e.g., G. Kokkoris, A. Tserepi, A. G. Boudouvis, and E. Gogolides, “Simulation of SiO₂ and Si feature etching for microelectronics and microelectromechanical systems fabrication”, J. Vac. Sci. Technol. A 22, 1896 (2004)).

The feature profile evolution is performed by various techniques such as a technique based on the level set method (e.g., G. Kokkoris, A. Tserepi, A. G. Boudouvis, and E. Gogolides, “Simulation of SiO₂ and Si feature etching for microelectronics and microelectromechanical systems fabrication”, J. Vac. Sci. Technol. A 22, 1896 (2004)), a technique based on the cell model (A. P. Mahorowala and H. H. Sawin, “Etching of polysilicon in inductively coupled Cl₂ and HBr discharges. II. Simulation of profile evolution using cellular representation of feature composition and Monte Carlo computation of flux and surface kinetics”, J. Vac. Sci. Technol. B 20, 1064 (2002)), and a technique based on the string model. Any of these techniques is typically performed by dividing time into finite time steps and determining the flux or surface growth rate in each step.

However, use of techniques for representing the profile by division into finite time steps may cause the problem of failing to correctly represent the profile evolution in the vicinity of the material interface. To solve this, it can be contemplated to decrease the time increment. However, the decrease of time increment causes the problem of increased computation time.

### SUMMARY OF THE INVENTION

According to an aspect of the invention, there is provided a simulation method configured to simulate a feature profile of a material surface, the simulation method including: using an algorithm of repeating a step of calculating a surface growth rate and a step of skipping the calculation of the surface growth rate, the surface growth rate being calculated in the step of skipping the calculation of the algorithm if the material surface traverses a material interface.

According to another aspect of the invention, there is provided a simulation program configured to cause a computer to simulate a feature profile of a material surface, the program causing the computer to perform: using an algorithm of repeating a step of calculating a surface growth rate and a step of skipping the calculation of the surface growth rate, the surface growth rate being calculated in the step of skipping the calculation of the algorithm if the material surface traverses a material interface.

### BRIEF DESCRIPTION OF THE DRAWINGS

FIG. 1 is a flow chart showing the overall simulation of the feature profile of a semiconductor device according to a first embodiment of the invention;

FIG. 2 is a schematic view for illustrating a level set function;

FIG. 3 is a flow chart for describing step S130 in more detail;

FIG. 4 is a schematic view for illustrating the determination method of step S250;

FIGS. 5A to 5C are schematic views of the initial profile, showing a simulation result based on the simulation method according to this embodiment, and showing a simulation result based on the simulation method of a comparative example, respectively;

FIG. 6 is a flow chart showing the time-evolution simulation of a surface profile according to a modification of this embodiment;

FIG. 7 is a flow chart showing the calculation of surface growth rate according to still another modification of this embodiment; and

FIG. 8 is a schematic view showing a simulation apparatus loaded with a simulation program according to a second embodiment of the invention.

### DETAILED DESCRIPTION OF THE INVENTION

Embodiments of the invention will now be described with reference to the drawings, in which like components are labeled with like reference numerals, and the detailed description thereof is omitted as appropriate.

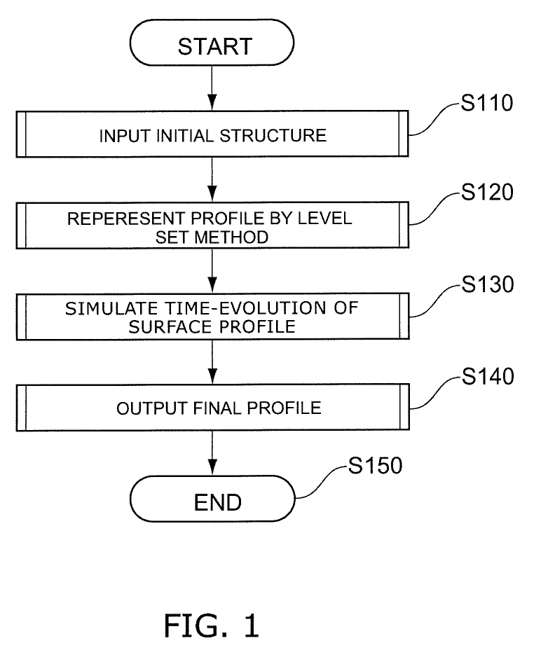

FIG. 1 is a flow chart showing the overall simulation of the feature profile of a semiconductor device according to a first embodiment of the invention.

First, an initial structure prior to processing is inputted (step S110). While various formats for input can be contemplated, this embodiment uses a technique of representing the material surface by a point sequence and reading it. Next, the inputted initial structure is used to create an initial level set function (step S120). In this embodiment, the two-dimensional level set method is used as a technique for profile representation. However, any other methods such as the three-dimensional level set method, cell method, and string method can also be used.

The level set function is now described.

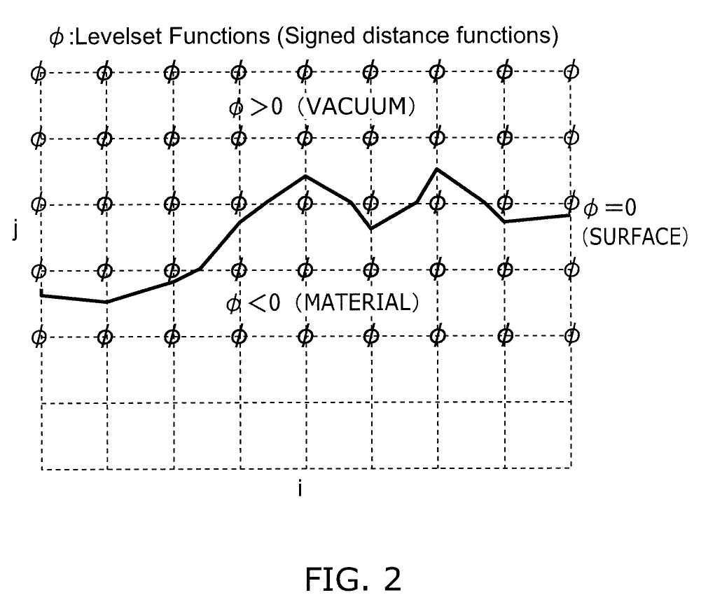

FIG. 2 is a schematic view for illustrating a level set function.

A level set function is defined using the distance from the material surface, and its value is saved on a mesh in the computational region. On the material surface, the level set function φ is defined to be “0” as given by the following equation:

φ=0 (surface) (1)

Furthermore, the level set function is given by φ>0 in a vacuum (outside the material), and by φ<0 in the material.

The initial level set function is calculated by searching for the nearest material surface from each mesh point and calculating the distance thereto. If the mesh point is located in the material, the sign is reversed.

Returning to FIG. 1, a surface growth rate F at each time step is calculated, and then the profile is time-evolved (step S130). Subsequently, the final profile is outputted (step S140), and the calculation ends (step S150).

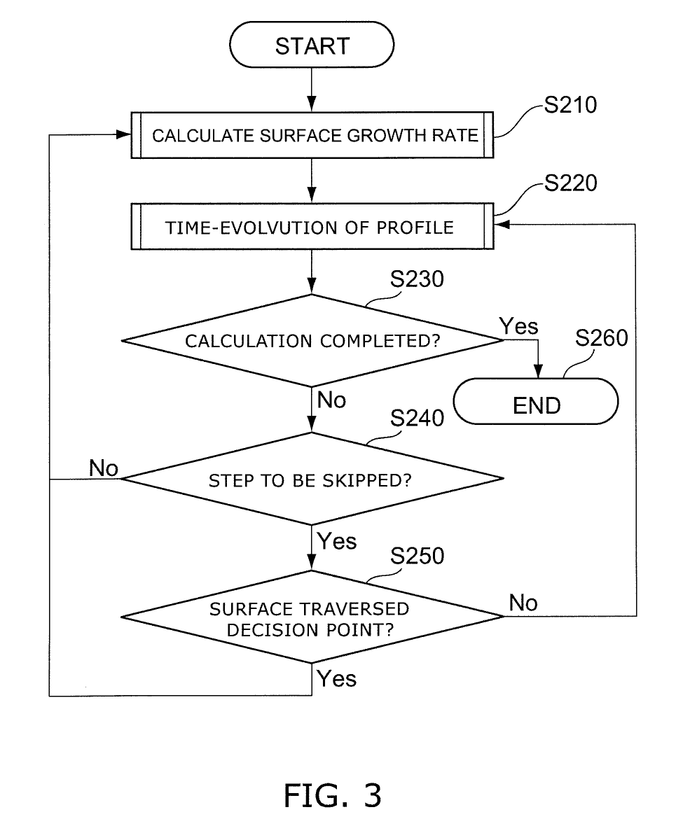

FIG. 3 is a flow chart for describing step S130 in the flow chart of FIG. 1 in more detail. The flow chart shown in FIG. 3 is an example providing a detailed description of the time-evolution simulation of the surface profile corresponding to step S130.

In the flow chart shown in FIG. 3, the calculation of surface growth rate is performed every several steps, and in the remaining calculation, the profile evolution of the level set based on the obtained surface growth rate is performed several times.

First, the surface growth rate Fᵢⱼ throughout the mesh is calculated (step S210). Here, “i” and “j” indicate a position in the mesh. The surface growth rate Fᵢⱼ throughout the mesh is determined by finding the surface growth rate at a local surface on the basis of a local ion flux or neutral species flux and distributing it over the mesh of the level set using the “fast marching method” or the like.

Next, the profile after Δt seconds is time-evolved on the basis of the following equation (step S220):

φₜ+F|∇φ|=0 (2)

where ∇ is the vector differential operator. This equation is discretized. From the level set function φᵢⱼⁿ in the n-th step on meshᵢⱼ, or mesh point (i,j), the level set function φᵢⱼⁿ⁺¹ in the (n+1)-th step after Δt seconds is illustratively determined by the following equations (3)-(10):

$$\begin{matrix}{φ}_{ij}^{n + 1} = {φ}_{ij}^{n} - Δ t {S}_{ij} & ( 3 ) \\ {S}_{ij} = [ max ( {F}_{ij} , 0 ) {∇}^{+} + min ( {F}_{ij} , 0 ) {∇}^{-} ] & ( 4 ) \\ {∇}^{+} = {[ \begin{matrix}{max ( {D}_{ij}^{- x} , 0 )}^{2} + {min ( {D}_{ij}^{+ x} , 0 )}^{2} + \\ max {( {D}_{ij}^{- y} , 0 )}^{2} + {min ( {D}_{ij}^{+ y} , 0 )}^{2}\end{matrix} ]}^{1 / 2} & ( 5 ) \\ {∇}^{-} = {[ \begin{matrix}{max ( {D}_{ij}^{+ x} , 0 )}^{2} + {min ( {D}_{ij}^{+ x} , 0 )}^{2} + \\ max {( {D}_{ij}^{+ y} , 0 )}^{2} + {min ( {D}_{ij}^{- y} , 0 )}^{2}\end{matrix} ]}^{1 / 2} & ( 6 ) \\ {D}^{+ x} {φ}_{ij}^{n} = \frac{{φ}_{( i + 1 ) j}^{n} - {φ}_{ij}^{n}}{Δ x} & ( 7 ) \\ {D}^{- x} {φ}_{ij}^{n} = \frac{{φ}_{ij}^{n} - {φ}_{( i - 1 ) j}^{n}}{Δ x} & ( 8 ) \\ {D}^{+ y} {φ}_{ij}^{n} = \frac{{φ}_{i ( j + 1 )}^{n} - {φ}_{ij}^{n}}{Δ y} & ( 9 ) \\ {D}^{- y} {φ}_{ij}^{n} = \frac{{φ}_{ij}^{n} - {φ}_{i ( j - 1 )}^{n}}{Δ y} & ( 10 )\end{matrix}$$

Sᵢⱼ represents a profile evolution factor. Δx represents mesh spacing in the x-direction, and Δy represents mesh spacing in the y-direction. While an explicit scheme based on the first-order upwind difference is used in equations (3)-(10), any other schemes can also be used. The level set function can be time-evolved by calculating equation (3) throughout the mesh.

Next, it is determined whether the calculation is completed (step S230). If it is determined that the calculation is completed (step S230, yes), the calculation ends (step S260). If it is determined that the calculation is to be continued (step S230, no), control proceeds to the next step (step S240). The determination of completion in step S230 can be based on any of the processing time t, the target point on the material surface, and the like.

Next, it is determined whether the current step is the step of skipping the calculation (step S240). For example, in the case of performing rate calculation once every five steps, assume that the surface growth rate Fᵢⱼ was previously calculated in the step “m”. Then, if the following equation holds, skipping is not applied to the current step (step S240, no), and control returns to step S210. If the following equation does not hold, skipping is applied to the current step (step S240, yes), and control proceeds to the next step (step S250).

n=m+5 (11)

Next, it is determined whether the material surface has traversed a prescribed decision point, e.g., a decision point at the material interface (step S250). If the material surface has traversed a decision point at the material interface (step S250, yes), control returns to step S210 and performs the calculation of surface growth rate Fᵢⱼ. On the other hand, if the material surface has not traversed a decision point at the material interface (step S250, no), control returns to step S220 and skips the calculation of surface growth rate Fᵢⱼ.

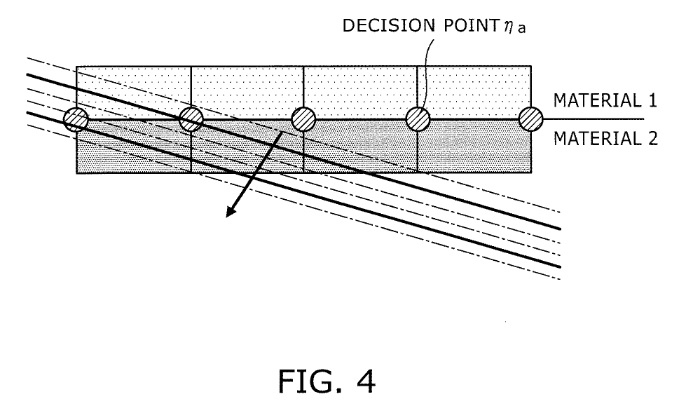

FIG. 4 is a schematic view for illustrating the determination method of step S250 in FIG. 3.

The determination method in step S250 can be implemented in various ways depending on the technique for profile representation. Here, the case of using the level set method is taken as an example for description.

As illustrated by the decision points shown in FIG. 4, A decision points ηₐ (a=1, 2, . . . , A) are specified in advance at suitably defined spacings at the interface between material 1 and material 2. While this spacing is arbitrary, it is preferable that this spacing be approximately equal to the mesh spacing (Δx or Δy). Furthermore, in the example described herein, the timing of specifying the decision points ηₐ is immediately after reading the profile in step S110 (see FIG. 1). However, this timing is not limited thereto, but can be any time before step S250.

Here, it is checked at each specified decision point ηₐ whether the level set function has changed sign. The level set function φₐⁿ in time step n is compared with the level set function φₐⁿ⁺¹ in the next time step, which is determined by time evolution based on the surface growth rate. If it has changed sign as represented by the following relation, it is assumed that the material surface has traversed the decision point at the material interface:

φₐⁿ×φₐⁿ⁺¹ (12)

This is checked for the decision points ηₐ (a=1, 2, . . . , A). If it is determined at least one decision point that the material surface has traversed the material interface, control returns to step S210, and the surface growth rate Fᵢⱼ is recalculated.

It is noted that the level set function at the decision point, which is not located on the mesh, can be determined by a technique of interpolation from the surrounding level set functions using interpolation functions.

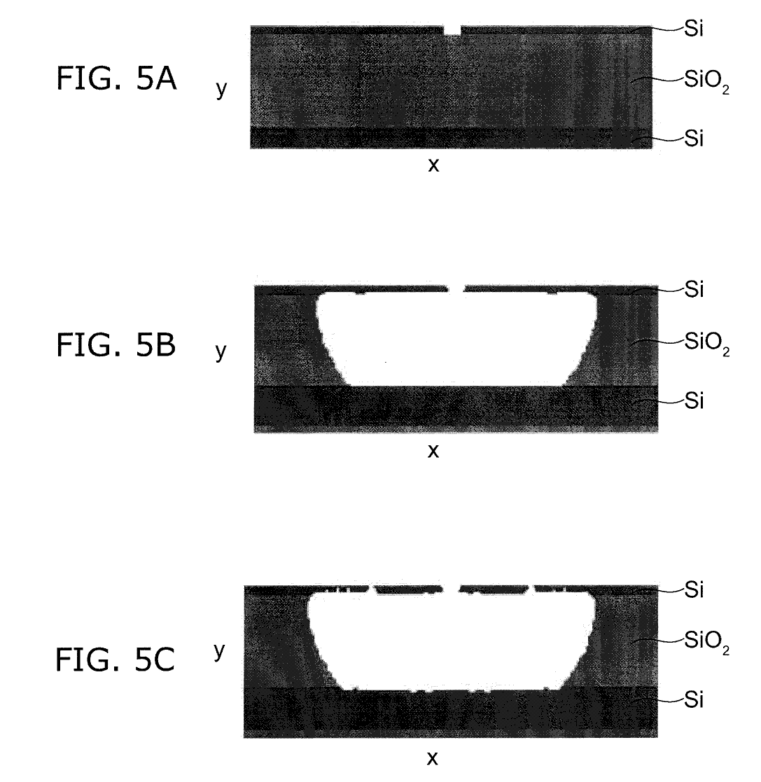

FIG. 5 is a schematic view illustrating feature profiles in the simulation of wet etching, in which FIG. 5A is a schematic view of the initial profile, FIG. 5B is a schematic view showing a simulation result based on the simulation method according to this embodiment, and FIG. 5C is a schematic view showing a simulation result based on the simulation method of a comparative example. In the comparative example, a simulation lacking step S250 (see FIG. 3) was performed.

This wet etching was based on a model in which the silicon (Si) portion shown in FIG. 5 is not etched, but only silicon dioxide (SiO₂) is isotropically etched. In the initial profile shown in FIG. 5A, a portion of the upper silicon (Si) has a hole, through which only silicon dioxide (SiO₂) is isotropically etched. The computational region was divided into 80 mesh points in the x-direction, and the calculation of the rate function was performed once every five steps (a determination like equation (11) was made in S240 (see FIG. 3)). Decision points ηₐ at the material interface were arranged at spacings equal to the mesh spacing Δx.

In the simulation result shown in FIG. 5B, the upper and lower silicon (Si) is scarcely etched. This is because no skip is introduced when the material surface is close to the material interface, hence significantly reducing error at the material interface. The computation time increases by a factor of approximately 1.1 as compared with the simulation method of the comparative example. However, in the case where no skip is introduced when the material surface is close to the material interface, the computation time is five times longer than in the simulation method of the comparative example. Hence, the simulation method of this embodiment achieves significant speedup.

In contrast, in the simulation result shown in FIG. 5C, the upper and lower silicon (Si) is etched. This is because the time-evolution technique based on the simulation method of the comparative example lacks step S250 (see FIG. 3), which results in substantially scraping off the silicon (Si) and increasing the profile error. To avoid this, it can be contemplated to decrease the frequency of skips. However, decreasing the frequency of skips undesirably increases the computation time.

As described above, according to this embodiment, it is determined whether a decision point has been traversed, and if a decision point has been traversed, the calculation of surface growth rate Fᵢⱼ is performed without skipping. Hence, the profile in the vicinity of the interface can be calculated more accurately.

In the following, modifications of this embodiment are described with reference to the drawings.

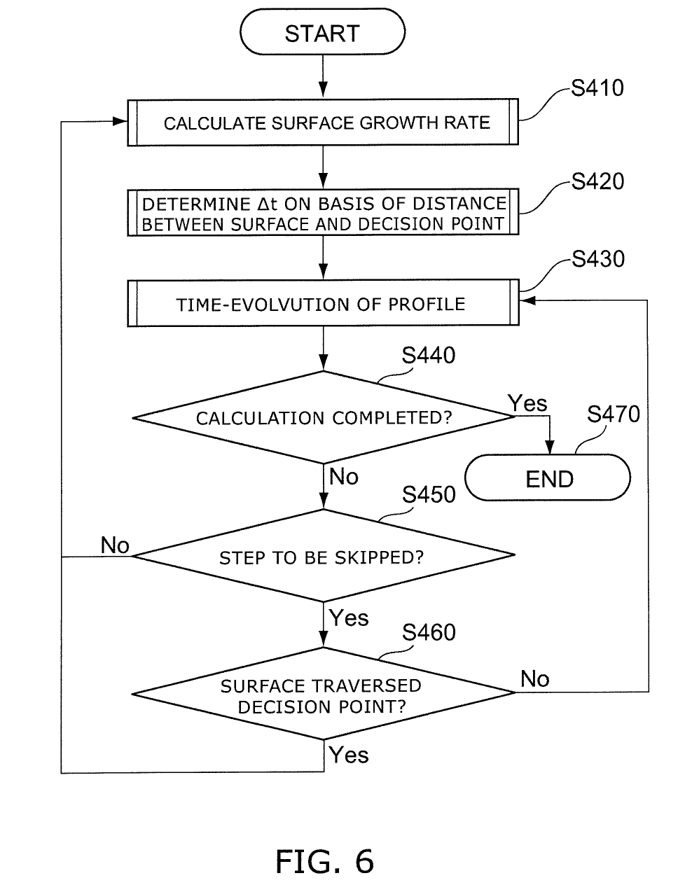

FIG. 6 is a flow chart showing the time-evolution simulation of a surface profile according to a modification of this embodiment.

The flow chart shown in FIG. 6 is an example providing a detailed description of the time-evolution simulation of a surface profile corresponding to step S130 (see FIG. 1).

The flow chart shown in FIG. 6 is different from the flow chart shown in FIG. 3 in that a step (step S420) of setting time increment Δt on the basis of the distance between the material surface and the decision point is added after the step (step S410) of calculating the surface growth rate Fᵢⱼ throughout the mesh. The steps other than step S420 are the same as those in the flow chart shown in FIG. 3, and hence the description thereof is omitted. It is noted that step S450 can be bypassed (corresponding to the case where the step m in which the surface growth rate Fᵢⱼ was calculated is “1”). Furthermore, step S460 can be omitted.

Conventionally, the time increment Δt is set to a value Δtᵢₙᵢₜ which is determined from the input value and the CFL condition before step S420 is performed:

Δt=Δtᵢₙᵢₜ (13)

In contrast, in the simulation method according to this modification, the time increment Δt is varied in accordance with the distance from the material surface.

Like the embodiment described with reference to FIGS. 1 to 5, A decision points ηₐ (a=1, 2, . . . , A) are specified in advance at suitably defined spacings at the material interface. In the level set method, the level set function at the material interface serves as the distance between the material surface and a decision point of interest. In the case where a decision point ηₐ reaches the material interface after time increment Δt_{just,a}, equation (3) yields the following equation:

0=φₐⁿ−Δt_{just,a}Sₐ (14)

where φₐⁿ is the level set function at the decision point ηₐ in step n. Sₐ is the level set evolution factor at the decision point ηₐ. This is determined by interpolating Sᵢⱼ obtained in equation (4).

Equation (14) is rewritten into the following equation:

$$Δ {t}_{just , a} = \frac{{φ}_{a}^{n}}{{S}_{a}} \qquad ( 15 )$$

Equation (15) can be used to calculate the time increment Δt_{just,a} in which the decision point ηₐ reaches the material interface.

By checking positive-valued Δt_{just,a} at the decision points (a=1, 2, . . . , A), the time Δtⱼᵤₛₜₐₗₗ at which at least one decision point traverses the material interface in the step of interest can be determined by the following equation:

Δtⱼᵤₛₜₐₗₗ=min(Δt_{just,a}) for all ηₐ of (Δt_{just,a}>0) (16)

In the case where Δtⱼᵤₛₜₐₗₗ satisfies equation (17), that is, in the case where the material interface is expectedly traversed in the step of interest, the time increment Δt is determined by equation (18):

0<Δtⱼᵤₛₜₐₗₗ<Δtᵢₙᵢₜ (17)

Δt=Δtⱼᵤₛₜₐₗₗ+ε(0<Δtⱼᵤₛₜₐₗₗ<Δtᵢₙᵢₜ) (18)

where ε is a small value, which can illustratively be determined by the following equation:

ε=10⁻⁶×Δtᵢₙᵢₜ (19)

This is intended for ensuring that the decision point of interest will have already traversed the material surface after the next and subsequent steps.

In the normal case where Δtⱼᵤₛₜₐₗₗ does not satisfy equation (17), the normal time increment Δtᵢₙᵢₜ is used as given by the following equation:

Δt=Δtᵢₙᵢₜ(Δtⱼᵤₛₜₐₗₗ<0,Δtᵢₙᵢₜ<Δtⱼᵤₛₜₐₗₗ) (20)

According to this modification, in addition to the embodiment described with reference to FIGS. 1 to 5, the time step is adjusted. Hence, the interface profile can be represented more accurately.

Next, another modification of this embodiment is described.

In determining Δt in the modification described with reference to FIG. 6, it is not necessarily needed to use the level set function at the decision point. For example, it is also possible to use the distance rᵢⱼ from the mesh point for each level set to the nearest material interface, which can be calculated and saved in advance. The timing of calculating and saving the distance rᵢⱼ can be either immediately after the input of the initial structure in step S110 (see FIG. 1) or not immediately after the input of the initial structure in step S110.

In this modification, the difference in the level set function between the mesh and the nearest material interface, Δφᵢⱼ^{bound}, is determined by the following equation:

Δφᵢⱼ^{bound}=φᵢⱼ−φ_{a,nearest} (21)

where φ_{a,nearest} is the level set function at the nearest material interface.

As represented by the following equations, a sign is hereinafter assigned to rᵢⱼ on the basis of the difference in the level set function between the mesh and the material interface:

Rᵢⱼ=rᵢⱼ(Δφᵢⱼ^{bound}>0) (22)

Rᵢⱼ=−rᵢⱼ(Δφᵢⱼ^{bound}<0) (23)

On the basis of Rᵢⱼ at meshᵢⱼ, the time increment Δt_{just,ij} allowing meshᵢⱼ to just represent the material interface is established by the following equation in analogy to the derivation of equation (15):

$$Δ {t}_{just , ij} = \frac{{φ}_{ij}^{n} - {R}_{ij}}{{S}_{ij}} \qquad ( 24 )$$

By calculating Δt_{just,ij} at the mesh points near the material interface, the time Δtⱼᵤₛₜₐₗₗ at which at least one mesh point having positive-valued Δt_{just,ij} traverses the material interface in the step of interest can be determined by the following equation:

Δtⱼᵤₛₜₐₗₗ=min(Δt_{just,ij}) for all meshᵢⱼ of (Δt_{just,ij}>0) (25)

This Δtⱼᵤₛₜₐₗₗ is substituted into equations (18) and (20) to determine the time increment Δt as in the modification described with reference to FIG. 6.

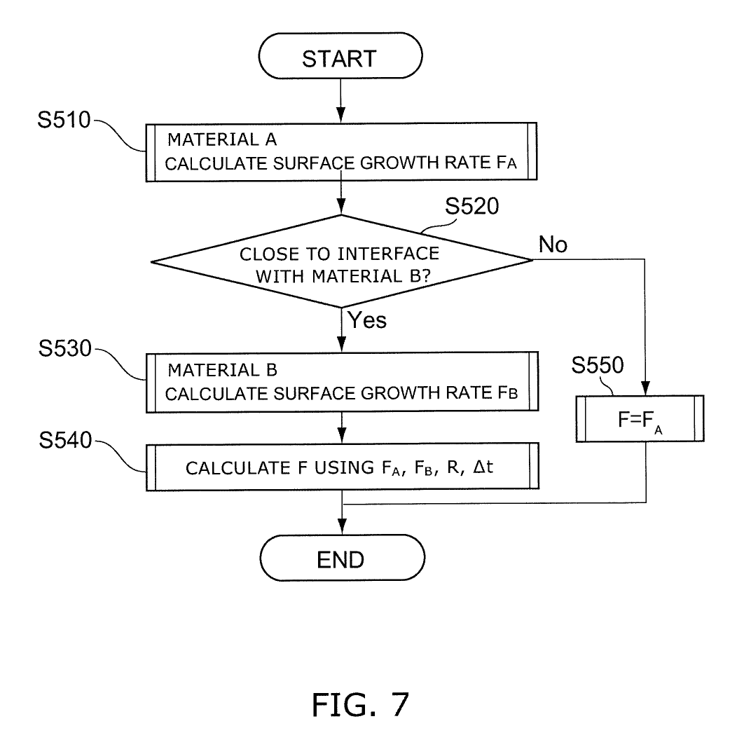

FIG. 7 is a flow chart showing the calculation of surface growth rate according to still another modification of this embodiment.

The flow chart shown in FIG. 7 is an example providing a detailed description of the calculation of surface growth rate corresponding to step S210 (see FIG. 3).

In the modification described with reference to FIG. 6, the time increment Δt is varied with the distance from the material interface. In contrast, this modification uses a technique of varying the surface growth rate Fᵢⱼ. In calculation for the material surface near the second material (hereinafter referred to as “material B”), the surface growth rate F_{B,ij} of material B is calculated in addition to the surface growth rate F_{A,ij} of the first material (hereinafter referred to as “material A”). The surface growth rate Fᵢⱼ reflecting both of them is calculated from F_{A,ij}, F_{B,ij}, the level set function φᵢⱼⁿ at the point of interest, the distance Rᵢⱼ to the material interface, and the time increment Δt. As described earlier, immediately after reading the profile, the distance Rᵢⱼ to the material interface can be calculated as the distance from each mesh point to the interface and saved.

Assuming that the surface growth rate is F_{A,ij} at each mesh point, the time to just reach the material interface is given, like equation (24), by the following equation:

$$Δ {t}_{just , ij} = \frac{{φ}_{ij}^{n} - {R}_{ij}}{{S}_{A , ij} ( {F}_{A , ij} )} \qquad ( 26 )$$

Hence, if the following relation holds, the remaining time is correctly calculated by using the surface growth rate F_{B,ij}:

0<Δt_{just,ij}<Δt (27)

Thus, the surface growth rate Fᵢⱼ at each mesh point can be determined by the following equation:

$${F}_{ij} = {F}_{A , ij} \frac{Δ {t}_{just , ij} + ɛ}{Δ t} + {F}_{B , ij} \frac{Δ t - Δ {t}_{just , ij} - ɛ}{Δ t} \qquad ( 28 )$$

where ε is a small value given by equation (19) and defined so that the material interface slightly enters the region of the fresh material. It is noted that this value can be omitted.

In the flow chart shown in FIG. 7, first, the surface growth rate F_{A,ij} of material A is determined (step S510). Next, the condition of equation (27) is checked to determine whether Rᵢⱼ is close to the interface with material B (step S520). If it is determined to be distant from the interface with material B (step S520, no), F_{A,ij} is directly used for the surface growth rate as given by the following equation (step S550):

Fᵢⱼ=F_{A,ij} (29)

On the other hand, if it is determined to be close to the interface with material B (step S520, yes), the surface growth rate F_{B,ij} of material B is determined (step S530). F_{B,ij} determined here can be either the surface growth rate of material B which is virtually determined at the same computational point, or a surface growth rate determined on the basis of the surface growth rate of material B which is virtually advanced one step. Next, the merged surface growth rate Fᵢⱼ of material A and material B is determined by equation (28) (step S540). This is performed likewise for all the mesh points in need of computation.

It is noted that what is merged can be the profile evolution factor Sᵢⱼ rather than the surface growth rate Fᵢⱼ. The profile evolution factor Sᵢⱼ is determined by the following equation:

$${S}_{ij} = {S}_{A , ij} \frac{Δ {t}_{just , ij} + ɛ}{Δ t} + {S}_{B , ij} \frac{Δ t - Δ {t}_{just , ij} - ɛ}{Δ t} \qquad ( 30 )$$

where ε is a small value given by equation (19) and defined so that the material interface slightly enters the region of the fresh material. It is noted that this value can be omitted.

Next, still another modification of this embodiment is described.

With regard to equation (28) in the modification described with reference to FIG. 7, in the case where two or more material interfaces are traversed, it is also possible to separately use an equation for averaging three or more materials after calculating distances to the two or more material interfaces. That is, the surface growth rate Fᵢⱼ is determined from the surface growth rate F_{A,ij} of material A, the surface growth rate F_{B,ij} of material B, the surface growth rate F_{C,ij} of material C, the distance to the AB material interface R_{AB,ij}, the distance to the BC material interface R_{BC,ij}, and the time increment Δt.

Next, a second embodiment of the invention is described.

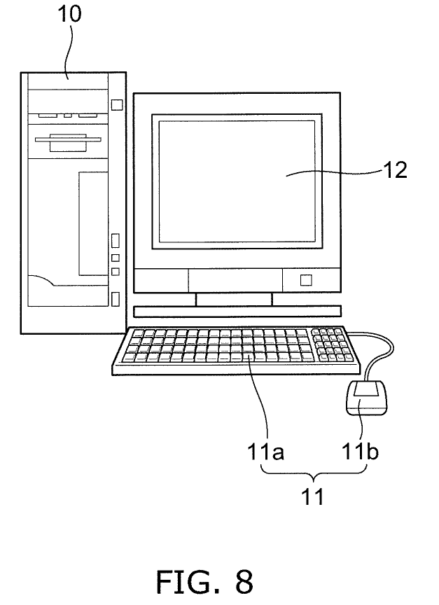

FIG. 8 is a schematic view showing a simulation apparatus loaded with a simulation program according to the second embodiment of the invention.

The simulation apparatus shown in FIG. 8 comprises a control unit 10, an input unit 11, and an output unit 12.

The control unit 10 includes a CPU (central processing unit) serving as a controller, and a ROM (read only memory) and a RAM (random access memory) serving as storage devices. The control unit 10 controls the input unit 11 and the output unit 12 and performs simulation. Upon input of prescribed instruction information from the input unit 11 by a user of the simulation apparatus, the CPU reads a simulation program and the like stored in the ROM, expands it in a program storage region in the RAM, and performs various processes including the simulation. Various data produced in these processes (simulation results) are stored in a data storage region created in the RAM.

The input unit 11 includes a keyboard 11a and a mouse 11b. Through the input unit 11, the user inputs information on calculation formulas, information on experimental and predicted values, information on the microstructure of the device, information on the flux, or instruction information (information on conditions and procedures) for performing simulation.

The output unit 12 includes display means such as a liquid crystal monitor. The output unit 12 outputs and displays the calculation results (simulation results) of the simulation calculated by the control unit 10.

As described above, the simulation apparatus loaded with a simulation program according to this embodiment comprises a control unit 10, an input unit 11, and an output unit 12. However, in addition, the simulation apparatus can further comprise a storage device such as a HDD (hard disk drive) or a CD (compact disc) drive unit.

In this case, it is also possible to provide the simulation program according to this embodiment by recording it as an installable or executable file on a computer-readable recording medium such as a CD-ROM, flexible disk (FD), CD-R, and DVD (digital versatile disk).

It is also possible to provide the simulation program according to this embodiment by storing it on a computer connected to a network such as the Internet and allowing it to be downloaded through the network. Furthermore, the simulation program according to this embodiment can also be provided or distributed through a network such as the Internet. Moreover, it is also possible to provide the simulation program according to this embodiment by preinstalling it in a ROM.

The embodiments of the invention have been described. However, the invention is not limited to the foregoing description. The above embodiments can be suitably modified by those skilled in the art without departing from the spirit of the invention, and any such modifications are also encompassed within the scope of the invention. For example, the techniques described in relation to the embodiments of the invention are applicable not only to simulating the surface processing of semiconductor devices, but also to simulating the surface processing in general. For example, such techniques are also applicable to simulations for processing MEMS (microelectromechanical systems) and display devices.

The elements included in the above embodiments can be combined with each other as long as technically feasible without departing from the spirit of the invention, and such combinations are also encompassed within the scope of the invention.

1. A simulation method configured to simulate a feature profile of a material surface, the simulation method comprising:
using an algorithm of repeating a step of calculating a surface growth rate and a step of skipping the calculation of the surface growth rate,
the surface growth rate being calculated in the step of skipping the calculation of the algorithm if the material surface traverses a material interface.

2. The method according to claim 1, wherein, in a step in which the material surface does not traverse the material interface, the calculation of the surface growth rate is skipped, and the feature profile is time-evolved.

3. The method according to claim 1, wherein the calculation of the surface growth rate is completed when a predetermined processing time has elapsed.

4. The method according to claim 1, wherein the calculation of the surface growth rate is completed when the material surface reaches a predetermined target point.

5. The method according to claim 1, wherein a time interval Δt of the steps is determined by using a distance from the material surface to the material interface and a surface growth rate.

6. The method according to claim 5, wherein the distance is a level set function at the material interface.

7. The method according to claim 1, wherein the material is etched and the surface growth rate is negative.

8. The method according to claim 1, wherein a time interval Δt of the steps is determined by using a level set function and a surface growth rate.

9. The method according to claim 8, wherein the level set function is a difference between the value of the level set function on a mesh in a computational region where the value is saved and the value of the level set function at the material interface nearest to the mesh.

10. The method according to claim 1, wherein the step in which the material surface traverses the material interface,
the calculating includes:
calculating a first surface growth rate before the traversal of the material interface and a second surface growth rate after the traversal of the material interface; and
using the first and second surface growth rate to calculate a new surface growth rate in the step.

11. The method according to claim 1, wherein the step in which the material surface traverses the material interface,
the calculating includes:
calculating profile evolution factors of two or more materials adjacent to the material interface; and
using the profile evolution factors to calculate a new profile evolution factor in the step.

12. A simulation program configured to cause a computer to simulate a feature profile of a material surface, the program causing the computer to perform:
using an algorithm of repeating a step of calculating a surface growth rate and a step of skipping the calculation of the surface growth rate,
the surface growth rate being calculated in the step of skipping the calculation of the algorithm if the material surface traverses a material interface.

13. The program according to claim 12, wherein, in a step in which the material surface does not traverse the material interface, the calculation of the surface growth rate is skipped, and the feature profile is time-evolved.

14. The program according to claim 12, wherein the calculation of the surface growth rate is completed when a predetermined processing time has elapsed.

15. The program according to claim 12, wherein the calculation of the surface growth rate is completed when the material surface reaches a predetermined target point.

16. The program according to claim 12, wherein a time interval Δt of the steps is determined by using a distance from the material surface to the material interface and a surface growth rate.

17. The program according to claim 16, wherein the distance is a level set function at the material interface.

18. The program according to claim 12, wherein a time interval Δt of the steps is determined by using a level set function and a surface growth rate.

19. The program according to claim 12, wherein in the step in which the material surface traverses the material interface,
the calculating includes:
calculating a first surface growth rate before the traversal of the material interface and a second surface growth rate after the traversal of the material interface; and
using the first and second surface growth rate to calculate a new surface growth rate in the step.

20. The program according to claim 12, wherein in the step in which the material surface traverses the material interface,
the calculating includes:
calculating profile evolution factors of two or more materials adjacent to the material interface; and
using the profile evolution factors to calculate a new profile evolution factor in the step.
